(19) United States
(12) Patent Application Publication
(10) Pub. No.: US 2017/0065069 A1
(43) Pub. Date: Mar. 9, 2017

(54) NANOBRUSHES AND METHODS OF MANUFACTURE AND USE

(71) Applicant: INDIAN INSTITUTE OF TECHNOLOGY KANPUR, Uttar Pradesh (IN)

(72) Inventors: Ramakrishna SUBRAMANIAM ANANTHA, Kanpur, Uttar Pradesh (IN); Jhuma DUTTA, Kanpur, Uttar Pradesh (IN)

(73) Assignee: INDIAN INSTITUTE OF TECHNOLOGY KANPUR, Uttar Pradesh (IN)

(21) Appl. No.: 15/122,404

(22) PCT Filed: Feb. 25, 2015
(86) PCT No.: PCT/IB2015/051388

§ 371 Date: Aug. 29, 2016

(30) Foreign Application Priority Data
Feb. 27, 2014 (IN) 548/DEL/2014

(51) Int. Cl. A46B 9/02; B08B 1/04; B08B 1/00; A46D 1/00; A46D 1/08

(52) U.S. Cl. CPC A46B 9/025; A46D 1/0207; A46D 1/08; B08B 1/002; B08B 1/04

(57) ABSTRACT

Nanobrushes, methods of forming nanobrushes, and methods of altering material with a nanobrush are disclosed herein. A nanobrush may include a substrate having a surface and a plurality of bristles deposited on at least one portion of the surface. The plurality of bristles may be arranged into a plurality of bunches. Each of the plurality of bunches may be spaced from an adjacent bunch at a bunch interval equal to or less than about 100 μm.

### BACKGROUND

Nanometer-sized brushes have been proposed recently for various applications such as brushing, cleaning, polishing, buffing, scratching, painting, and/or the like of small surfaces, such as, for example, surfaces of microelectromechanical systems (MEMS).

However, because of the extremely small scale required for nanobrushes, manufacturing techniques have resulted in uniform, blanket depositions of nanorods over a substrate. Such a uniform, blanket deposition may not be desirable for particular applications. For example, a uniform distribution may be disadvantageous when the nanobrush is applied to surfaces containing features such as depressions, protrusions, and/or the like. In addition, a uniform distribution can result in effective brushing and/or cleaning only near the edges of the brush.

In addition, the extremely small scale of nanobrush manufacture has required the use of only certain materials for construction. In some instances, such materials may not be desirable because the materials may have a propensity to damage certain surfaces, an inability to clean certain surfaces, an inability to properly coat certain surfaces, and/or the like, Such materials may further not have a desired mechanical strength, hardness, and/or the like that may be required for particular applications.

### SUMMARY

In an embodiment, a nanobrush may include a substrate having a surface and a plurality of bristles deposited on at least one portion of the surface. The plurality of bristles may be arranged into a plurality of bunches. Each of the plurality of bunches may be spaced from an adjacent bunch at a bunch interval equal to or less than about 100 micrometers (μm).

In an embodiment, a method of forming a nanobrush may include providing a substrate having a patterned surface and depositing a bristle material on at least a portion of the surface of the substrate to form a plurality of bunches on the surface of the patterned surface. The bundles may include a plurality of bristles. Depositing may include controlling at least one deposition parameter such that the bunches are spaced from an adjacent bunch at a bunch interval equal to or less than about 100 μm and the bunches are arranged in at least one configuration.

In an embodiment, a method of altering a material may include applying a nanobrush to the material to alter the material. The nanobrush may include a substrate having a surface and a plurality of bristles deposited on at least one portion of the surface. The plurality of bristles may be arranged into a plurality of bunches. Each of the plurality of bunches may be periodically spaced from an adjacent bunch at a bunch interval equal to or less than about 100 μm.

### BRIEF DESCRIPTION OF THE DRAWINGS

FIG. 1 depicts an illustrative side perspective view of a plurality of bristles arranged into a bunch according to an embodiment.

FIG. 2 depicts an illustrative top perspective view of a bristle according to an embodiment.

FIG. 3 depicts an illustrative side perspective view of a plurality of bunches arranged into a plurality of clusters according to an embodiment.

FIG. 4A depicts an illustrative top perspective view of a plurality of bunches according to an embodiment.

FIG. 4B depicts an illustrative top perspective view of a plurality of clusters according to an embodiment.

FIG. 5 depicts illustrative bristle arrangements according to various embodiments.

FIG. 6 depicts cross-sectional side view of a textured substrate according to an embodiment.

FIG. 7 depicts an illustrative top view of a textured substrate according to an embodiment.

FIGS. 8A-8C depict flow diagrams of a method of forming a nanobrush according to an embodiment.

FIGS. 9A-9D depict various scanning electron microscope (SEM) images of an illustrative nanobrush patterned onto a substrate according to an embodiment.

FIG. 10 depicts various SEM images of another illustrative nanobrush patterned onto a substrate according to an embodiment.

FIG. 11 depicts various SEM images of an illustrative nanobrush patterned on a laser machined glass substrate according to an embodiment.

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

As used herein, a “nanobrush” generally refers to various brushes that have nanometer-sized linear dimensions. The nanobrushes described herein are sufficiently sized such that they can be used on micro- and sub-micro sized objects. The nanobrushes have bristles that are nanofibers of various materials, as described herein. Illustrative nanobrushes may include nano-sized brushes, nano-sized paintbrushes, and nano-sized fans.

The present disclosure relates generally to nanobrushes having bristles that have been deposited in particular patterns instead of a blanket, uniform distribution typically found on conventional nanobrushes. The particular patterns include areas with higher and lower bristle densities, areas with no bristles or substantially no bristles, various spatial properties of bristles, particular bristle dimensions, particular bristle shapes, particular bristle angles, and/or the like. Such particular patterns allow the nanobrushes to be tuned for particular applications such that the nanobrush is more effective than commonly used nanobrushes. The particular patterns may allow the nanobrush to be more effective because it can reach areas on a target material that were previously unreachable by a uniform distribution of bristles, around areas that must not be damaged by the bristles, provide specific patterns and/or locations of bristle contact, and/or the like. Illustrative uses for which the nanobrush can be particularly tuned may include polishing a material, buffing a material, scratching a material, cleaning a material, painting a material, and/or the like. The nanobrush may additionally be applied in a number of different ways, such as, for example, applying in a reciprocating motion, applying in a sliding motion, and applying in a rotating motion. Such motions may be possible by mounting the nanobrushes on other devices, such as, for example, piezo tips or the like.

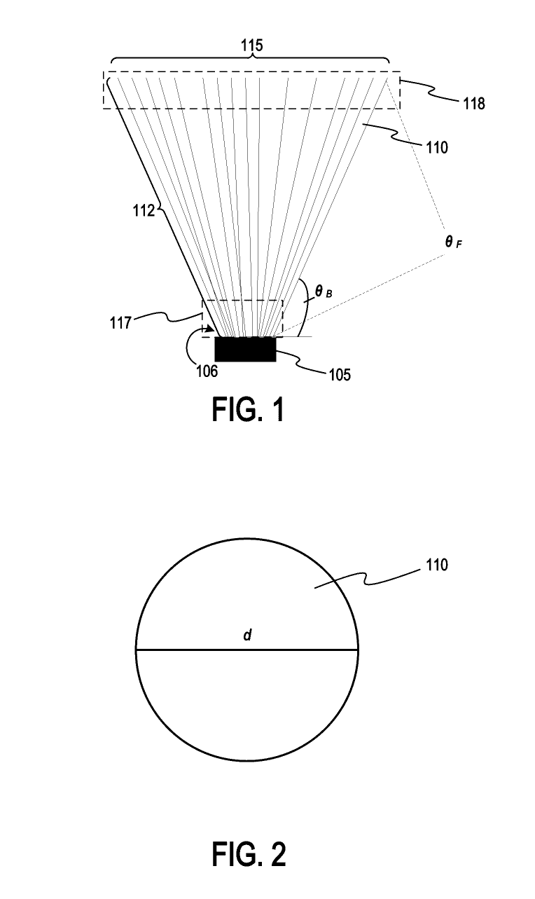

FIG. 1 depicts an illustrative side perspective view of a plurality of bristles 110 arranged into a bunch 115 according to an embodiment. The plurality of bristles 110 may generally be deposited on at least one portion of a substrate 105, such as, for example, a surface 106 of the substrate.

In various embodiments, the bristles 110 may be deposited on the surface 106 such that a base portion 117 of the bristles is located proximally to the surface and a tip portion 118 is located distally to the surface. The base portion 117 may generally be tightly packed such that the bristles 110 are located in close proximity to one another. In contrast, the tip portion 118 may generally be loosely packed, particularly with respect to the base portion 118. Such a configuration may cause the bunch 115 to be flared from the base portion 117 to the tip portion 118 at a flare angle θ_{F} with respect to a normal of the substrate surface 106. As described in greater detail herein, the bunch 115 may exhibit a minimal amount or no amount of flaring. Illustrative minimal flare angles θ_{F} may include, but are not limited to, about 0° to about 30° with respect to the normal of the surface 106, including about 0°, about 5°, about 10°, about 15°, about 20°, about 25°, about 30°, or any value or range between any two of these values (including endpoints).

The bristles 110 may be deposited on the surface 106 of the substrate 105 such that various portions of the substrate have a density of bristles thereon. In some embodiments, the surface 106 of the substrate 105 may have a constant density of bristles deposited thereon. In other embodiments, various portions of the surface 106 of the substrate 105 may have a bristle density that varies from other portions of the surface of the substrate. For example, various portions of the substrate 105 may have a lower density of bristles 110 than other portions of the substrate. Similarly, various portions of the substrate 105 may have a higher density of bristles 110 than other portions of the substrate. The density of bristles 110 may be calculated as an average density of bristles, bunches, or clusters over a known surface area of the substrate 105, such as, for example, the average density of the entire nanobrush. Illustrative average densities of a nanobrush may include, but are not limited to, about 0.01 bunches per square micrometer to about 100 bunches per square micrometer. For example, the average density of a nanobrush may be about 0.01 bunches/μm², about 0.1 bunches/μm², about 1 bunch/μm², about 5 bunches/μm², about 10 bunches/μm², about 15 bunches/μm², about 20 bunches/μm², about 25 bunches/μm², about 30 bunches/μm², about 40 bunches/μm², about 50 bunches/μ², about 60 bunches/μm², about 70 bunches/μm², about 75 bunches/μm², about 80 bunches/μm², about 90 bunches/μm², about 100 bunches/μm², or any value or range between any two of these values (including endpoints).

In various embodiments, the bristles 110 may be deposited at an angle θ_{B} with respect to the surface 106 of the substrate 105. Illustrative angles may be about 5° with respect to the surface 106 of the substrate 105 to about 90° with respect to the surface of the substrate. For example, the angle may be about 5°, about 10°, about 15°, about 20°, about 25°, about 30°, about 35°, about 40°, about 45°, about 50°, about 55°, about 60°, about 65°, about 70°, about 75°, about 80°, about 85°, about 90°, or any value or range between any two of these values (including endpoints).

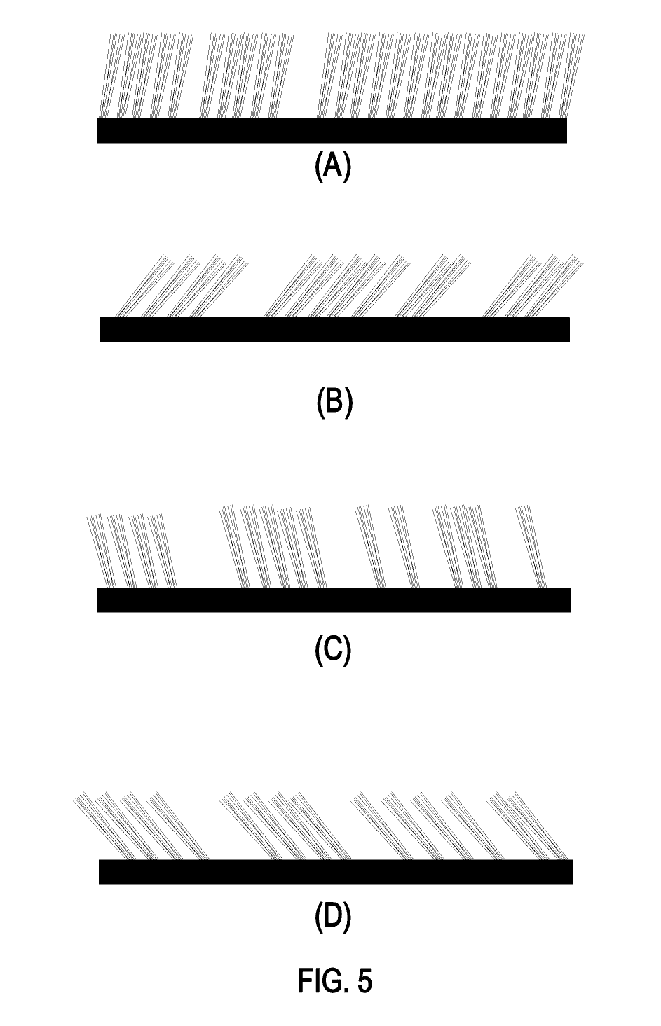

In some embodiments, all of the bristles 110 may be deposited at the same angle. In other embodiments, only a portion of the bristles 110 may be deposited at the same angle. For example, each bunch 115 may have its constituent bristles 110 deposited at the same angle, which may be different from another bunch. Similarly, a cluster of bunches (as described in greater detail herein) may have its constituent bristles 110 deposited at the same angle, which may be different from another cluster. FIG. 5 depicts various illustrative orientations of bristles having varying angles with respect to the surface of the substrate. For example, orientation (A) depicts several clusters having bristles deposited at a similar oblique angle, which is less than 90° to the right with respect to the surface of the substrate. Similarly, orientation (B) depicts several clusters having bristles deposited at a similar oblique angle. Orientation (C) depicts several clusters having bristles that are deposited at an oblique angle to the left with respect to the surface of the substrate. Similarly, orientation (D) depicts several clusters having bristles deposited at a similar oblique angle. Other deposition angles and orientations not specifically described herein will also be apparent to those having ordinary skill in the art, and the present disclosure is intended to include such angles and orientations.

Referring to FIG. 1, the bristles 110 may generally have any size and/or shape. For example, each bristle 110 may be generally columnar with a cross-sectional shape. In another example, each bristle 110 may be generally conical with a cross-sectional shape. The cross-sectional shape of each bristle 110 may be regular or irregular. In some embodiments, the cross-sectional shape of a bristle 110 may be circular. In some embodiments, the cross-sectional shape of a bristle 110 may be substantially circular. Other illustrative cross-sectional shapes may include, but are not limited to, elliptical, triangular, rectangular, pentagonal, hexagonal, heptagonal, octagonal, and the like.

Each bristle 110 may generally have a length l. The length l may be measured from the base portion 117 to the tip portion 118 of each bristle 110. In some embodiments, the length l may be an average length of at least a portion of the bristles 110, such as, for example, an average length of all the bristles in a bunch 115. In some embodiments, the length l may be an average length of all the bristles 110 deposited on the substrate 105. The length l may generally be about 200 nanometers (nm) to about 10 micrometers (μm). For example, the length l may be about 200 nm, about 300 nm, about 400 nm, about 500 nm, about 600 nm, about 700 nm, about 800 nm, about 900 nm, about 1 μm, about 2 μm, about 3 μm, about 4 μm, about 5 μm, about 6 μm, about 7 μm, about 8 μm, about 9 μm, about 10 μm, or any value or range between any two of these values (including endpoints).

Each bristle 110 may also have a diameter. Measurement of the diameter may generally include measuring a distance from a first side of the cross section of the bristle 110 to an opposite side. For example, as shown in FIG. 2, a bristle 110 having a circular or substantially circular shape may have a diameter d that is measured from a first side of the bristle to an opposite side of the bristle, as indicated by the straight line bisecting the circle. In some embodiments, the diameter d may be measured as an average diameter of at least a portion of the bristles 110, such as, for example, all of the bristles in a bunch 115 (FIG. 1). In some embodiments, the diameter d may be an average diameter of all bristles 110 deposited on the substrate 105. The diameter d may generally be about 20 nm to about 100 nm. For example, the diameter d may be about 20 nm, about 25 nm, about 30 nm, about 35 nm, about 40 nm, about 45 nm, about 50 nm, about 55 nm, about 60 nm, about 65 nm, about 70 nm, about 75 nm, about 80 nm, about 85 nm, about 90 nm, about 95 nm, about 100 nm, or any value or range between any two of these values (including endpoints).

Referring also to FIG. 1, the bristles 110 may have an aspect ratio of the length l to the diameter d. In some embodiments, the aspect ratio may be based upon an average length l of the bristles 110, as described in greater detail herein. Similarly, the aspect ratio may be based upon an average diameter d of the bristles 110, as described in greater detail herein. The aspect ratio of the length l to the diameter d may generally be about 5:1 to about 100:1. For example, the aspect ratio may be about 5:1, about 10:1, about 20:1, about 25:1, about 30:1, about 40:1, about 50:1, about 60:1, about 70:1, about 75:1, about 80:1, about 90:1, about 100:1, or any value or range between any two of these values (including endpoints).

The bristles 110 may be made of any type of material, including, but not limited to, materials now known or later developed for nanobrushes. Illustrative materials may include a dielectric material, a metallic material, a semiconducting material, and a combination thereof. Particular materials, as described in greater detail herein, may include silicon dioxide, calcium fluoride, and magnesium fluoride. The material may generally be selected based upon a particular application of the nanobrush, as described in greater detail herein.

The dielectric material may generally be a substance exhibiting a negligible amount of electrical conductivity. Accordingly, the dielectric material may include ion-conducting materials, non-ion-conducting materials, or combinations thereof. Illustrative examples of ion-conducting materials may include any ionomer or electrolyte suitable to a given application, such as, for example, ion-exchange polymers, alkaline solutions, acidic solutions, phosphoric acid, alkali carbonates, and oxide ion-conducting ceramics. Illustrative examples of non-ion-conducting materials may include polymers such as polypropylene, polyethylene, polycarbonate, polyethylene ether ketones, polyimides, polyamides, fluoropolymers, and other polymer films. Illustrative examples of fluoropolymers may include polytetrafluoroethylene (PTFE), perfluorosulfonic acid (PFSA), fluorinated ethylene propylene (FEP), and perfluoroalkoxyethylene (PFA). The dielectric material may also include reinforced composite materials such as fiberglass, any suitable non-polymer materials such as silicon or glass, or a combination thereof. In some embodiments, the dielectric material may include an electrolyte, which may include a solid electrolyte membrane.

The metallic material may generally be a metal, a metal alloy, or a mixture thereof. Illustrative examples of a metallic material may include, but are not limited to, calcium (Ca), chromium (Cr), molybdenum (Mo), magnesium (Ma), tungsten (W), ruthenium (Ru), copper (Cu), silver (Ag), and gold (Au).

The semiconducting material may generally be a material that exhibits semiconducting properties. For example, the semiconducting material may be selected from silicon, germanium, calcium, magnesium, tin, gallium arsenide, indium tin oxide, alloys thereof, and mixtures thereof. In some embodiments, the semiconducting material may be pure (such as, for example, intrinsic or i-type silicon) or doped (such as, for example, silicon containing a n-type or p-type dopant, such as phosphorous or boron, respectively). In some embodiments, the semiconducting material may include at least one dopant selected from boron (B), phosphorous (P), chloride (Cl), fluoride (Fl), or aluminum (Al). The amount of dopant present in the semiconducting material may be chosen based on the desired dopant concentration and distribution in the produced article of semiconducting material and may depend on the final use of the nanobrush. Those skilled in the art will recognize a necessary temperature distribution based on various thermal properties of the semiconducting material, such as heat capacity, thermal conductivity, and/or latent heat of fusion.

In some embodiments, the bristles 110 may be made of at least one carbon nanotube. The carbon nanotube is not limited by this disclosure, and may generally be any elongated carbon structure. For example, the carbon nanotube may be a fullerene-related structure that includes graphene cylinders. In some embodiments, a carbon nanotube may be a carbon nanotube column, which may include a group of bundled carbon nanotubes that is generally vertically aligned. Some of the carbon nanotubes in the group may overlap, may be comingled or intertwined, or may otherwise contact one or more other carbon nanotubes in one or more places.

In some embodiments, the bristles 110 may be made of at least one zinc oxide nanopillar. As used herein, a nanopillar may generally be a pillar-shaped structure that may be grouped with other nanopillars in a lattice-like array. A bristle 110 may be a single nanopillar or may be a grouping of nanopillars.

In some embodiments, the bristles 110 may be made of at least one polymer. The polymer is generally not limited by this disclosure, and may be any polymer, particularly polymers suitable for nanobrush applications. In particular embodiments, the polymer may be a bio-compatible polymer. One illustrative bio-compatible polymer is a parylene (poly(p-xylylene)). In some embodiments, the polymer may include a hydrocarbon polymer, a fluorinated polymer, a silicon containing polymer, and/or the like. Illustrative examples of hydrocarbon polymers may include, but are not limited to, polyolefins, polydienes, and/or polystyrene. Illustrative examples of polyolefins may include, but are not limited to, polyethylene, polypropylene, poly(1-butene), poly(4-methyl-1-pentene), and blends, mixtures, and copolymers thereof. Illustrative examples of fluorinated polymers may include polytetrafluoroethylene (PTFE), perfluoroalkylvinyl ether (PFA), fluorinated ethylene-propylene copolymer (FEP), ethylene tetrafluoroethylene copolymer (ETFE), polyvinylidene fluoride (PVDF), polychlorotrifluoroethylene (PCTFE), and/or tetrafluoroethylene (TFE). Illustrative examples of silicon containing polymers may include, but are not limited to, silicates, siloxanes such as hydrogen silsesquioxane (HSQ), hexamethyldisiloxane, octamethyltrisiloxane, and the like, silazanes such as polysilazanes, hexamethyldisilazane (HMDS), tetramethyldisilazane, octamethylcyclotetrasilazine, hexamethylcyclotrisilazine, diethylaminotrimethylsilane, dimethylaminotrimethylsilane, and the like, and silisesquioxanes such as hydrogen silsesquioxane (HSQ).

In various embodiments, the bristles 110 may be formed from silicon and/or silicon-containing compounds. For example, the bristles 110 may be formed from silicon dioxide. Thus, the bristles 110 may include fused quartz, crystal, fumed silica, silica gel, aerogel, and/or the like. The silicon and/or silicon-containing compounds will be recognized by those with skill in the art as suitable for electric insulating nanobrushes. Other applications that are particularly suited for silicon dioxide-based bristles may include polish processes in semiconductor processing (high hardness and/or silicon compatibility), timed-release chemical action in a cleaning/coating/painting process, drug delivery/bandages (inertness and/or moisture adsorption capacity), surfaces with customized adhesion strength (by varying the length, density, and/or angle of the bristles, the pattern of the bundles, and/or the like).

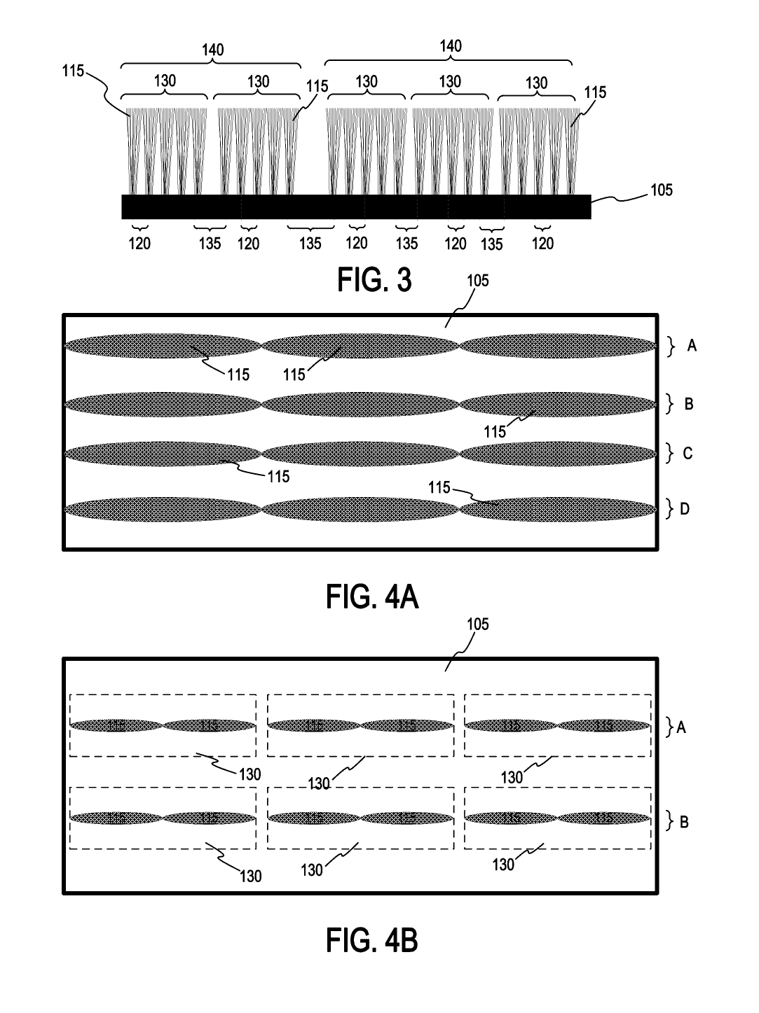

As shown in FIG. 3, the bunches 115 of bristles may be arranged on the substrate 105. In some embodiments, each bunch 115 may be spaced from an adjacent bunch at a bunch interval 120. In some embodiments, a bunch interval 120 may be equal to other bunch intervals. In other embodiments, a bunch interval 120 may differ from at least one other bunch interval. Thus, the bunch interval 120 may cause a spacing between the bunches 115 to be periodic, non-periodic, or quasi-periodic. The bunch interval 120 may be equal to or less than about 100 μm. In some embodiments, the bunch interval 120 may be greater than about 100 nm. In some embodiments, the bunch interval 120 may be less than about 100 μm and greater than about 100 nm. For example, the bunch interval 120 may be about 100 nm, about 200 nm, about 300 nm, about 400 nm, about 500 nm, about 600 nm, about 700 nm, about 800 nm, about 900 nm, about 1 μm, about 10 μm, about 20 μm, about 25 μm, about 50 μm, about 75 μm, about 100 μm, or any value or range between any two of these values (including endpoints). In some embodiments, the bunch interval 120 may be about 400 nm to about 800 nm. In some embodiments, the bunch interval 120 may be about 100 nm to about 20 μm.

The bunches 115 may further be arranged in any manner on the substrate. For example, the bunches 115 may be arranged in one or more clusters 130. Each cluster 130 may contain at least two bunches 115. In some embodiments, the spatial arrangement of each cluster 130 may be independent of the arrangement of the bunches 115. Thus, for example, a cluster interval 135 may be greater or smaller than a bunch interval 120. In some embodiments, a cluster interval may be a fraction of the length of a period of bunches 140. The fraction may generally be less than or equal to about ½ of the length of the period of bunches 140. For example, the fraction may be about 1/32, about 1/16, about ⅛, about ⅓ about ¼, about ½, or any value or range between any two of these values (including endpoints).

FIGS. 4A and 4B depict other arrangements of bunches 115 and/or clusters 130 on the surface of the substrate 105. As shown in FIG. 4A, the bunches 115 may be arranged such that the bristles are arranged in a plurality of rows A, B, C, D. As shown in FIG. 4B, the clusters 130 may be arranged such that the bristles are arranged in a plurality of rows A, B.

Those with ordinary skill in the art will recognize the various features, materials, arrangements, and densities of the bristles as described herein that may affect a porosity of the nanobrush. The porosity of the nanobrush may generally be calculated as an average porosity exhibited by the nanobrush. Illustrative porosities may be about 5% to about 50%. For example, the porosity may be about 5%, about 10%, about 15%, about 20%, about 25%, about 30%, about 35%, about 40%, about 45%, about 50%, or any value or range between any two of these values (including endpoints).

Referring back to FIG. 1, the substrate 105 may generally be any substrate, particularly substrates suitable for various nanobrush applications. Accordingly, the substrate 105 may be made of any number of materials, including, for example, glass, silicon, gold, a polymer sheet, and/or a combination thereof The polymer sheet may generally be any thermoplastic polymer composition formed by any suitable method into a thin layer that is suitable as a single layer or in stacks of more than one layer.

The substrate 105 is not limited in size by this disclosure, and may generally be any size, particularly sizes suitable for nanobrush applications. Similarly, the size of the substrate 105 upon which the bristles 110 are deposited is also not limited by this disclosure. An illustrative surface area of a portion of the substrate surface 106 upon which the bristles 110 are deposited may be about 60 square micrometers (μm²) to about 1 square meter (m²). Thus, for example, the surface area may be about 60 μm², about 100 μm², about 250 μm², about 500 μm², about 750 μm², about 1 mm², about 10 mm², about 50 mm², about 100 mm², about 250 mm², about 500 mm², about 7500 mm², about 1 m² or any value or range between any two of these values (including endpoints). In addition, the substrate 105 may be dividable into various smaller portions. For example, mass-produced nanobrushes may be formed on the same large substrate 105, which is later divided into the individual nanobrushes, as described in greater detail herein.

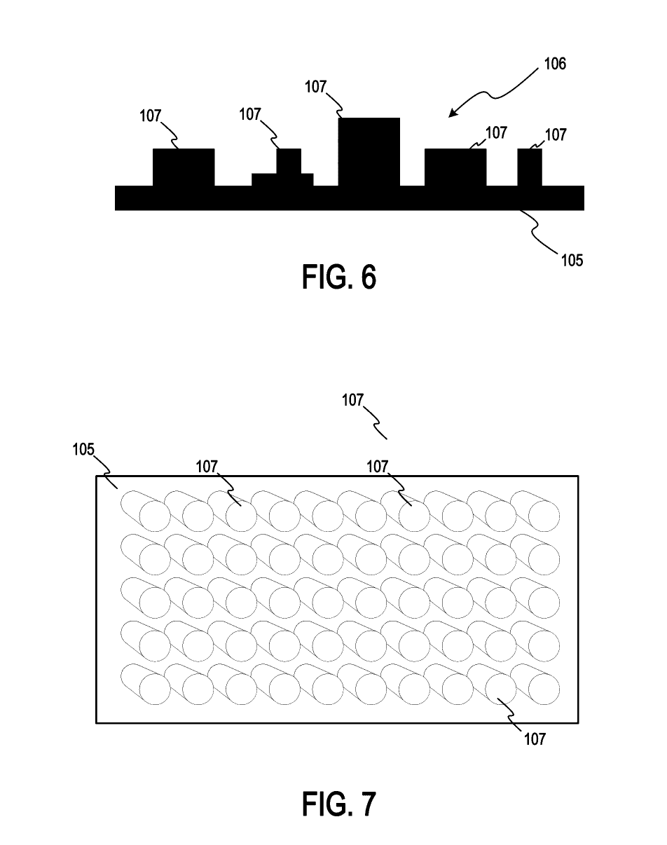

As depicted in FIGS. 6 and 7, the surface 106 of the substrate 105 may have various features 107 thereon such that the substrate is a patterned substrate having a patterned surface. The various features 107 are not limited by this disclosure and may generally be any impressions and/or protrusions on the substrate 105. The various features 107 may be of any shape and/or size, and may further be distributed over any portion of the substrate 105. For example, the various features 107 may be a plurality of impressions that are arranged on the surface 106 of the substrate 105 in a periodic array pattern. A specific example may be various holes arranged in a square or hexagonal array. It will be recognized that the size of the various features 107 may determine a type of patterned substrate 105. Thus, for example, if the various features 107 are generally shaped and sized such that they have linear dimensions that are about 0.01 nm to about 999 nm, the substrate 105 may have a nano-patterned surface 106. Similarly, if the various features 107 are generally shaped and sized such that they have linear dimensions that are about 1 μm to about 999 μm, the substrate 105 may have a micro-patterned surface 106.

Because of the shapes and sizes of the various features 107, in some embodiments, portions of the features may not have any bristles 110 deposited thereon. For example, various depths of impressions in the surface 106 of the substrate 105 may be such that a bristle 110 would not extend to a target object when the nanobrush is applied to the target object. Accordingly, such impressions may have substantially no bristles 110 arranged thereon. However, the bristles 110 may be arranged on portions of the substrate 105 not containing the impressions. In some embodiments, the various features 107 of the patterned substrate 105 may have a depth modulation of about 100 nm to about 1 mm. For example, the depth modulation of the patterned substrate 105 may be about 100 nm, about 500 nm, about 1 μm, about 50 μm, about 100 μm, about 250 μm, about 500 μm, about 750 μm, about 1 mm, or any value or range between any two of these values (including endpoints).

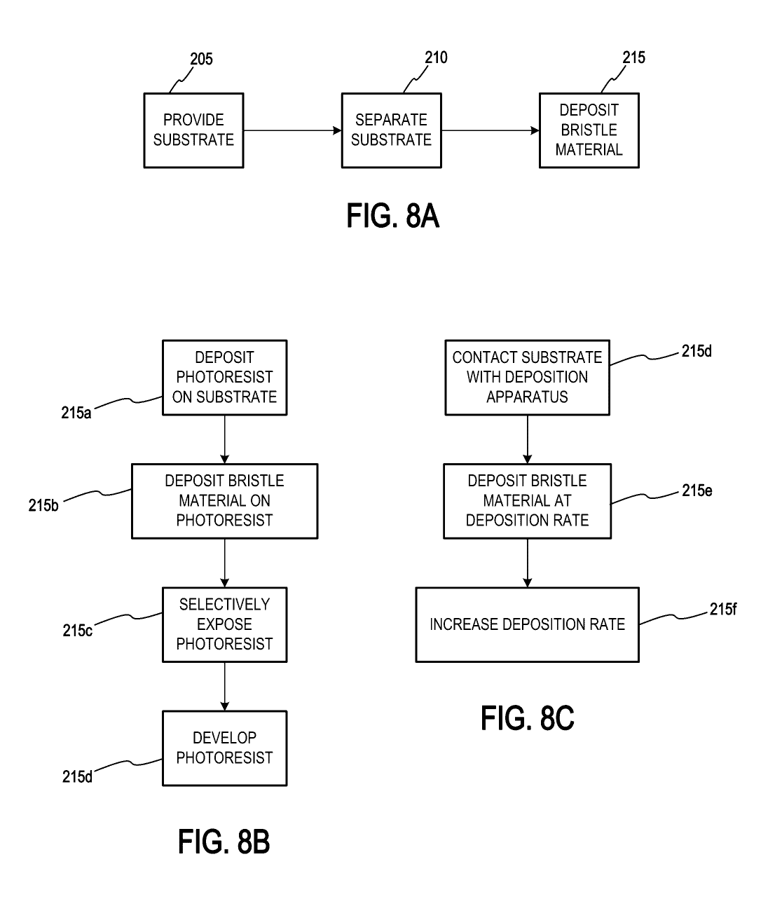

FIG. 8A depicts a flow diagram of a general method of forming a nanobrush according to an embodiment. The method may include providing 205 a substrate, such as, for example, the various substrates described herein. In some embodiments, the substrate may be an unpatterned substrate, In other embodiments, the substrate may be a patterned substrate. In embodiments where the provided 205 substrate is unpatterned, the substrate may be patterned prior to deposition 215 of the bristle material. Patterning is not limited by this disclosure, and may generally be any method of patterning, particularly methods that produce a patterned substrate as described herein. Illustrative patterning methods may include photo-lithography, electron beam lithography, nano-imprinting techniques, milling via a focused ion beam, laser machining, and/or the like. Photo-lithography may be a general process of transferring a pattern or photomask to the surface of the substrate. Photo-lithography may also include a combination of steps, such as, for example, substrate preparation, photoresist application, drying, exposure, developing, and etching. In some embodiments, patterning may include forming one or more valleys in the substrate such that the valleys are asked from receiving incoming flux, which, in turn prevents bristles from being deposited 215 therein, as described in more detail herein.

In various embodiments, the substrate may be separated 210 into a plurality of portions. Separation 210 may be completed, for example, in embodiments where a large substrate is formed for a plurality of nanobrushes. The separation 210 may be completed to form the individual nanobrushes from the large substrate. Separation 210 may include pre-marking the substrate by applying pressure to the substrate in order to form scratches with a diamond tip.

The bristle material may be deposited 215 on the substrate. In some embodiments, the bristle material may only be deposited 215 on a portion of the substrate. In other embodiments, the bristle material may be deposited 215 on the entire substrate. Deposition 215 of the bristle material may cause a formation of a plurality of bunches and/or a plurality of clusters, as described in greater detail herein.

In some embodiments, deposition 215 may include controlling at least one deposition parameter. Illustrative deposition parameters may include, but are not limited to, a deposition rate, a deposition angle, a frequency of deposition, spacing, location, and/or the like. The deposition rate may generally refer to an amount of bristle material that is deposited 215 on the substrate. In some embodiments, the amount of bristle material may be measured by weight or mass. In other embodiments, the amount of bristle material may be measured by a length or an average length. An illustrative deposition rate may be a length over a period of time, such as about 7 Angstroms per second (Å/s) to about 45 Å/s. For example, the deposition rate may be about 7 Å/s, about 8 Å/s, about 9 Å/s, about 10 Å/s, about 15 Å/S, about 20 Å/s, about 25 Å/s, about 30 Å/s, about 35 Å/s, about 40 Å/s, about 45 Å/s or any value or range between any two of these values (including endpoints). The deposition angle may generally refer to an angle with respect to the surface of the substrate at which the bristle material is deposited 215. Illustrative deposition angles may be about 5° to about 90° with respect to the surface of the substrate. For example, the deposition angle may be about 5°, about 10°, about 15°, about 20°, about 25°, about 30°, about 35°, about 40°, about 45°, about 50°, about 55°, about 60°, about 65°, about 70°, about 75°, about 80°, about 85°, about 90°, or any value or range between any two of these values (including endpoints).

Controlling the at least one deposition parameter may ensure that the bristle material is deposited 215 on the substrate in a desired manner. For example, the deposition parameters may ensure that the resultant bristles have an appropriate length, have an appropriate diameter, have an appropriate flare angle, are appropriately arranged into bunches and/or clusters, are appropriately spaced, are appropriately aligned, cover an appropriate amount of the surface area of the substrate, have an appropriate density, have an appropriate porosity, and/or the like. For example, in some embodiments, controlling the at least one deposition parameter may ensure that the bunches of bristles are spaced from an adjacent bunch at a bunch interval that is less than or equal to about 100 μm, as described in greater detail herein. In addition, controlling the at least one deposition parameter may ensure that the bunches are arranged in at least one configuration, such as the configurations described herein.

The various methods described herein may allow for a precise control of the orientation of the bristles and the bristle density during deposition 215. While the angle with which the flux is incident on the substrate controls the gross orientation direction and density of the bristles, it is possible to achieve a fine control on the orientation of the bristles and density by tuning the vapor (mass) flux rates. Typically, each nanocolumn that includes the bristle grows along the flux direction, but also expands in a lateral direction in a cauliflower-like grown pattern. This results in nanobrushes with typically flaring out bristles having a gross bristle directionality. The lateral expansion of individual bristles can be prevented by continuously increasing the rate of deposition with the increase in nanocolumn height that reduces the available time for surface diffusion of the deposited atoms, as described in greater detail herein. This would allow the growth of straight long bristles with minimal to no flaring, as described herein. For example, the deposition rate may be increased by about 2 Å/s to about 3 Å/s after every 100 nm thickness for silicon dioxide. Such a well-defined directionality can be obtained by appropriately increasing the rates of the deposition 215 depending on the tendency of the material for lateral growth. This would vary with temperature as the surface mobility that determines the lateral grown processes depends weakly on the substrate temperature.

Depositing 215 the bristle material on the substrate can be completed in any number of ways. For example, one method of deposition 215 may be similar to commonly known lithographic methods, as shown in FIG. 8B. Accordingly, the method may include depositing 215a a photoresist (either positive or negative) material on the substrate, depositing 215b the bristle material on the photoresist material, selectively exposing 215c the photoresist material in one or more areas, and developing 215d the photoresist. The photoresist material and/or the bristle material may be removed in the areas where the photoresist material was exposed 215c. The photoresist material is not limited by this disclosure and can generally be any photoresist now known or later developed. An illustrative photoresist material may include MegaPosit™ SPR™ 955-CM photoresist available from the Dow Chemical Company (Midland, Mich.). Another illustrative photoresist material may include ma-P 1205, available from micro-resist technology GmbH (Berlin, Germany). Exposing 215c the photoresist material may be completed according to any method now known or later developed, such as, for example, exposing the photoresist material to ultraviolet light and an organic developer. Illustrative organic developers may include, for example, a developer containing sodium hydroxide or a developer that is metal-ion free, such as tetramethylammonium hydroxide.

An alternative method of depositing 215 the bristle material is shown in FIG. 8C. In this method, the substrate is contacted 215d with a deposition apparatus. The deposition apparatus may be, for example, an extrusion head or the like that is configured to deposit bristle material in accordance with the present disclosure. The bristle material may be initially deposited 215e at a first deposition rate. The deposition rate may be increased 215f to create a column of bristle material, as described in greater detail herein. As previously described herein, increasing the deposition rate may be completed so as to minimize an amount of flare of the bunches of bristles.

Other methods of deposition 215 may include, for example, physical vapor deposition and chemical vapor deposition. Such methods are well known and allow for an easy application of the specific configuration of bristles, as described herein. Physical vapor deposition (PVD) refers to a deposition method where a component, such as the bristle material, is initially placed into a vacuum chamber in a nongaseous form. The non-gaseous component may be called the “source.” The vacuum chamber may be evacuated to a sub-atmospheric pressure prior to and during the deposition process. Sufficient energy and temperature may be applied to the source to change it to a vapor state. The vapor may be transported within the vacuum chamber onto the substrate. Due to a high vacuum having a low pressure of about 10⁻⁶ mbar, the vapor molecules that leave the source may travel directly to the substrate without colliding with each other (source to substrate distance is larger than mean free path). Heating processes using resistive heating, e-beam heating, rf or microwave heating, or sputtering processes by a plasma beam, an ion beam, or a laser beam may be used to convert the source into vapor phase. Illustrative PVD methods may include, for example, sputtering, reactive sputtering, evaporation, reactive evaporation, ion-assisted reactive evaporation, ion-beam assisted deposition, cathodic arc evaporation, unbalanced magnetron sputtering, high power impulse magnetron sputtering (HIPIMS), thermal and electron beam (e-beam) evaporation, and the like. Chemical vapor deposition (CVD) refers to a deposition method that is similar to PVD. Various precursor gases (often diluted in carrier gases) are delivered into a reaction chamber at a controlled temperature. As they pass over or come into contact with a warmer substrate, they react or decompose to form a solid phase of the bristle material on the substrate. The substrate temperature is critical and can influence what reactions will take place. Illustrative CVD methods may include, but are not limited to, atmospheric pressure chemical vapor deposition (APCVD), low pressure chemical vapor deposition (LPCVD), metal-organic chemical vapor deposition (MOCVD), plasma assisted chemical vapor deposition (PACVD) or plasma enhanced chemical vapor deposition (PECVD), laser chemical vapor deposition (LCVD), photochemical vapor deposition (PCVD), and chemical vapor infiltration (CVI).

### EXAMPLES

### Example 1

### Periodically Patterned Calcium Fluoride Nanobrushes

Periodically patterned nanobrushes are formed by providing a silicon-based substrate and depositing a calcium fluoride bristle material thereon. Before deposition of the bristle material, the substrate is prepared via laser interference lithography to form various patterns.

The bristle material is formed by placing an amount of calcium fluoride in a vacuum chamber and using physical vapor deposition to deposit the bristle material on the substrate at an oblique angle of about 75° with respect to the surface of the substrate. The bristles are deposited such that they have an average diameter of about 30 nm and an average height of about 1.6 μm.

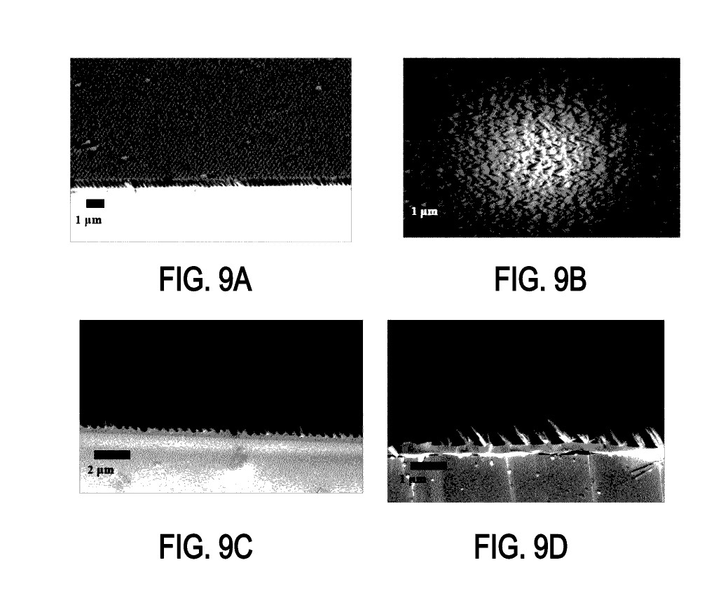

As shown in FIGS. 9A and 9B, the bristles are generally uniform across a large area. Particularly, FIG. 9A shows a perspective side view of the angle of the bristles and FIG. 9B shows a top surface view of the nanobrush including the orientation of the bristles. FIG. 9C shows the nanobrushes with bunches spaced at a periodicity of 600 nm. FIG. 9D shows the nanobrushes with bunches spaced at a periodicity of 800 nm.

Such a spacing and distribution of bristles results in a nanobrush that is suitable for providing a uniform application over a textured surface that would not be achieved with a uniform, blanket deposition of bristles.

### Example 2

### Periodically Patterned Silicon Dioxide Nanobrushes

Periodically patterned nanobrushes are formed by providing a silicon-based substrate and depositing a silicon dioxide bristle material thereon. Before deposition of the bristle material, the substrate is prepared via laser interference lithography to form various patterns.

The bristle material is formed by placing an amount of silicon dioxide in a vacuum chamber and using physical vapor deposition to deposit the bristle material on the substrate at an oblique angle of about 60° with respect to the surface of the substrate. The bristles are deposited such that they have an average diameter of about 50 nm and an average length of about 600 nm.

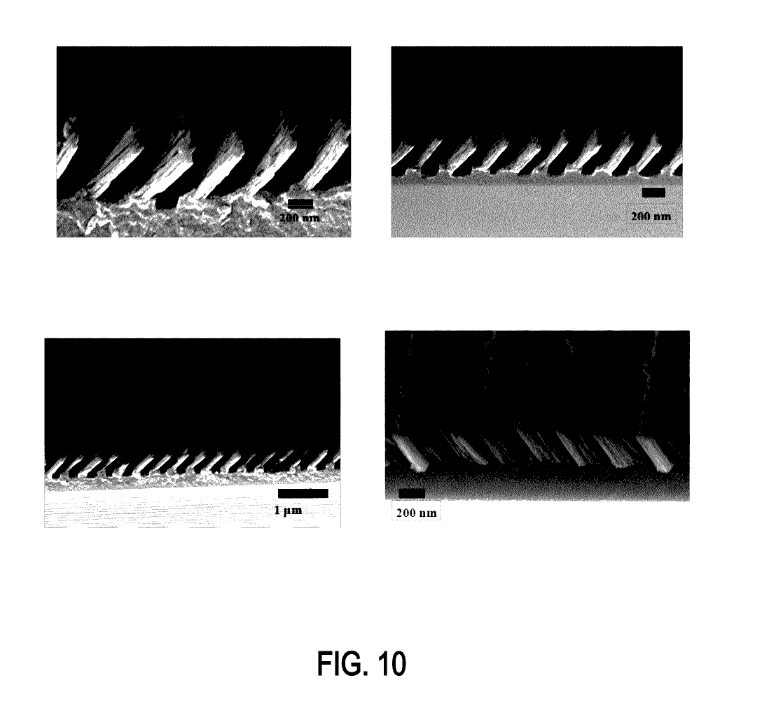

As shown in the images of FIG. 10, the bristles are generally uniform across a large area. Particularly, the images show a perspective side view of the angle of the bristles in bunches spaced at a periodicity of 500 nm-600 nm.

Such a spacing and distribution of bristles results in a nanobrush that is suitable for providing a uniform application over a textured surface that would not be achieved with a uniform, blanket deposition of bristles.

### Example 3

### Periodically Patterned Magnesium Fluoride Nanobrushes

Periodically patterned nanobrushes are formed by providing a laser-machined glass substrate and depositing a magnesium fluoride bristle material thereon. The bristle material is formed by placing an amount of magnesium fluoride in a vacuum chamber and using physical vapor deposition to deposit the bristle material on the substrate at an oblique angle of about 50° with respect to the surface of the substrate. The bristles are deposited such that they have an average diameter of about 100 nm in diameter and have an average length of about 900 nm.

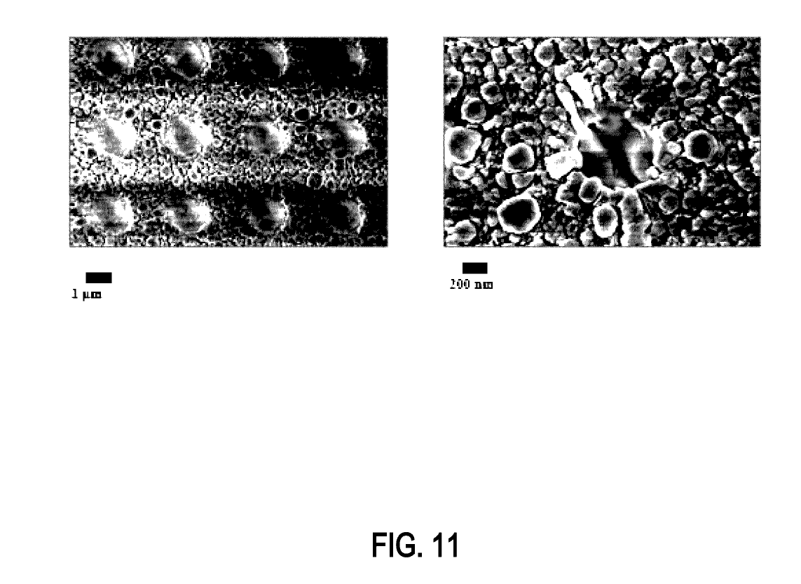

As shown in the images of FIG. 11, the bristles leave several hollow regions for particular applications. The hollow regions are used for reservoirs of chemicals, paints or are used as injection points from the substrate for chemicals and paints for various nanocleaning, nanobrushing, and nanopainting applications.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases one or more or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera As a non-limiting example, each range discussed herein can be readily broken down into a lower third, middle third and upper third, et cetera As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A nanobrush comprising:
a substrate comprising a surface; and
a plurality of bristles deposited on at least one portion of the surface, wherein the plurality of bristles are arranged into a plurality of bunches, and wherein each of the plurality of bunches is spaced from an adjacent bunch at a bunch interval equal to or greater than about 400 nm.

2. The nanobrush of claim 1, wherein each bunch of the plurality of bunches is spaced from an adjacent bunch by one or more of a periodic spacing, an adjacent spacing and a quasi-periodical spacing.

3.-4. (canceled)

5. The nanobrush of claim 1, wherein the bunch interval is about 400 nm to about 800 nm.

6. (canceled)

7. The nanobrush of claim 1, wherein each bunch interval is one or more of an equal interval and an unequal interval.

8. (canceled)

9. The nanobrush of claim 1, wherein the plurality of bunches are arranged in a plurality of rows.

10. The nanobrush of claim 1, wherein the plurality of bunches are arranged into one or more clusters of bunches, each cluster having at least two bunches and having a spatial arrangement independent of the bunches.

11. The nanobrush of claim 10, wherein the one or more clusters comprise a plurality of clusters, wherein each cluster is periodically spaced from an adjacent cluster at a cluster interval, wherein the cluster interval is a fraction of a period of the at least two bunches, and wherein the fraction is less than or equal to about ½.

12. The nanobrush of claim 10, wherein the one or more clusters comprise a plurality of clusters, and wherein the plurality of clusters are periodically spaced in a plurality of rows.

13. (canceled)

14. The nanobrush of claim 1, wherein each bunch of the plurality of bunches comprises a base portion and a tip portion, the base portion located proximally to the surface of the substrate and containing the plurality of bristles in a tightly packed configuration and the tip portion located distally to the surface of the substrate and containing the plurality of bristles in a loosely packed configuration such that each bunch is flared from the base portion to the tip portion.

15. The nanobrush of claim 14, wherein each bunch is disposed at a flare angle of about 0° to about 30° with respect to a normal of the surface of the substrate.

16. The nanobrush of claim 1, wherein each bristle of the plurality of bristles has a diameter of about 20 nm to about 100 nm and a length of about 200 nm to about 10 μm.

17. (canceled)

18. The nanobrush of claim 1, wherein each bristle of the plurality of bristles has an aspect ratio of length to diameter of about 5:1 to about 100:1.

19. The nanobrush of claim 1, wherein each bristle of the plurality of bristles is disposed on the substrate at an angle of about 5° to about 90° with respect to the surface of the substrate.

20.-21. (canceled)

22. The nanobrush of claim 1, wherein each of the plurality of bristles comprises at least one carbon nanotube.

23. The nanobrush of claim 1, wherein the plurality of bristles comprise at least one zinc oxide nanopillar.

24. The nanobrush of claim 1, wherein the plurality of bristles comprise at least one polymer.

25.-32. (canceled)

33. The nanobrush of claim 1, wherein the nanobrush has an average porosity of about 5% to about 50%.

34. A method of forming a nanobrush, the method comprising:
providing a substrate comprising a patterned surface; and
depositing a bristle material on at least a portion of the surface of the substrate to form a plurality of bunches on the surface of the patterned surface, the bunches comprising a plurality of bristles,
wherein depositing comprises controlling at least one deposition parameter such that:
the bunches are spaced from an adjacent bunch at a bunch interval equal to greater than about 400 nm; and
the plurality of bunches are arranged in at least one configuration.

35.-36. (canceled)

37. The method of claim 34, wherein depositing comprises arranging the plurality of bunches in a flared configuration, wherein bunch comprises a base portion and a tip portion, the base portion located proximally to the surface of the substrate and containing the bristles in a tightly packed configuration, and the tip portion located distally to the surface of the substrate and containing the bristles in a loosely packed configuration.

38. The method of claim 34, wherein depositing the a bristle material comprises depositing at an angle of about 5° to about 90° with respect to the surface of the patterned substrate.

39. (canceled)

40. The method of claim 34, wherein depositing the bristle material comprises:
contacting the substrate with a deposition apparatus;
depositing the bristle material at a first deposition rate; and
removing the deposition apparatus from the substrate while continuously increasing the deposition rate to a second deposition rate such that a column of the bristle material is formed.

41. The method of claim 34, wherein depositing the bristle material comprises:
depositing a photoresist material on the substrate;
depositing the bristle material on the photoresist material; and
exposing the photoresist material in one or more areas, wherein the exposed photoresist material and the bristle material thereon are removed from the substrate in the one or more areas.

42.-50.

51. The method of claim 34, wherein depositing comprises depositing the bunches in one or more clusters, wherein each cluster comprises at least two bunches.

52. The method of claim 34, wherein providing the substrate comprises providing a substrate selected from a glass substrate, a silicon substrate, a gold substrate and a polymer sheet.

53.-55. (canceled)

56. A method of altering a material, the method comprising:
applying a nanobrush to the material to alter the material, wherein the nanobrush comprises:
a substrate comprising a surface; and
a plurality of bristles deposited on at least one portion of the surface,
wherein the plurality of bristles are arranged into a plurality of bunches, and
wherein each of the plurality of bunches is periodically spaced from an adjacent bunch at a bunch interval equal to or less than about 100 μm.

57. The method of claim 56, wherein altering the material comprises one or more of buffing, scratching, cleaning, and painting.

58.-61. (canceled)

62. The method of claim 56, wherein applying the nanobrush to the material comprises applying the nanobrush in one or more of a reciprocating motion, a sliding motion and a rotating motion.

63.-64. (canceled)
